(19) United States
(12) Patent Application Publication
(10) Pub. No.: US 2011/0300318 A1
(43) Pub. Date: Dec. 8, 2011

(54) INSULATED PANEL SYSTEM AND STRUCTURE

(76) Inventors: Scott Jewett, Mission Viejo, CA (US); Jeffrey D. Cohen, La Jolla, CA (US); Daniel Dell 'Aquila, Irvine, CA (US); Robert Metcalf, Los Angeles, CA (US); Harvey Jewett, San Diego, CA (US)

(21) Appl. No.: 13/107,393

(22) Filed: May 13, 2011

Related U.S. Application Data
(60) Provisional application No. 61/350,475, filed on Jun. 2, 2010.

(51) Int. Cl. F16B 5/07; B32B 3/06

(52) U.S. Cl. 428/33; 428/99

(57) ABSTRACT

One embodiment of the present invention provides an insulated panel system for enhanced insulation of an existing structure, the system comprising an additional insulated layer provided on the surface of an existing structurally insulated panel, attachment means for attaching the additional insulated layer to the existing structurally insulated panel, wherein the additional insulated layer comprises a rigid foam panel and surface sheet stock sandwiching the foam panel. Another embodiment provides a structurally insulated panel and connection means, comprising a plurality of rigid insulating foam panels, a plurality of mating rails to provide structural support, and resin-based sheet stock sandwiching the foam panels and mating rails.

### REFERENCE TO RELATED APPLICATIONS

This application claims priority to U.S. Provisional Patent Application No. 61/350,475 filed Jun. 2, 2010, which is incorporated herein by reference in its entirety.

### TECHNICAL FIELD

The present invention relates generally to insulated panel systems and structures, and more particularly to enclosed, temperature-controlled structures and methods for construction.

### DESCRIPTION OF THE RELATED ART

There is a significant need for easily deployable, well-insulated structures to provide storage for items that require temperature control. These structures include, but are not limited to: walk-in refrigerators, food storage buildings, computer server rooms, equipment rooms, and freezers.

It is typical to construct walk-in refrigerators/freezers from panels of insulation, often urethane foam or fiberglass, covered in sheet metal. These panels are made in a production line and then linked together at the final site using a cam-lock system that compresses linear gaskets to create a connection and a seal at the seams. The cam-lock system is typically a hook that swings outward to engage a receiving pin on the adjacent panel. These cam-locks are expensive and complicated to install. They also require holes drilled into each cam-lock site in order to insert a tool to activate the locking action.

Constructing the insulated panels requires building a frame covered in sheet metal. The frame is often made of high-density urethane foam, metal, or wood. The sheet metal is then attached to both sides of the frame, as a canvas stretched over a frame, to yield an enclosed panel. This panel is retained in a large press, and liquid urethane foam is injected through a small opening. The foam then expands to fill the void. The foam's pressure is counteracted by the press. Once the foam cures, the finished panel is removed from the press. Making custom panel sizes requires that the frame and sheet metal panels be cut to desired sizes and then assembled. The foam also must be metered to ensure both that the panel is filled, and that not too much foam is wasted by overfilling.

The conventional method has a number of disadvantages. Almost all large refrigeration panels are constructed the same way. A frame with a tongue or groove exterior is fabricated using wood or high-density urethane foam. Both faces of the open frame are skinned in sheet metal. This assembly forms the exterior of the completed structurally insulated panel. The empty, metal-skinned frame is retained in a press and expanding urethane foam is injected. Once expanded, the panel is ready for assembly.

Attaching the panels together is accomplished with a cam and receiver pin system. Prior to skinning with sheet metal, cams are installed on one frame edge and the receiving panel edge has a receiving pin installed. An approximately ½″ hole is drilled through the sheet metal to allow the engagement of a tool used to rotate the cam device. Similar to turning the handle on a common sliding door latch, this swings a hook out to grab and engage the receiving pin on the opposing panel. As the panels are pulled snuggly together by the cams, rubber gaskets are used to effectuate a seal between the metal exteriors of the joined panels. This system is expensive, does not create a seamless connection, and requires drilling holes in the exterior finish. It also creates an area of reduced insulation, as the frame is a poor insulator. In addition, it creates an air-filled void in which the metal skins conduct heat. Further, the seams are a sanitation concern as they create a crevice for bacterial and fungal growth. An average-sized walk-in refrigerator often required the installation of hundreds of these cam devices and thus half as many access holes bored through the exterior sheet metal skins. Only half as many holes are drilled because one hole per set of cams is required (a set is a cam device and its receiving pin on the opposing panel). These holes are required to be capped and sealed per health department standards.

Prior art construction systems and methods for walk-in refrigerators require expensive, custom fabrication of frames. The cam and receiver connectors require significant labor, lower the insulation efficiency, and require boring holes in the exterior of the panels. Further, sheet metal dents easily. Colors require the application of an exterior paint that can scratch and flake. Such systems use metal, which is a poor insulator and makes the completed system heavy, and thus expensive to ship and difficult to assemble. Additionally, none of the prior art provides for improved insulation by eliminating the air gap between joined panels. All joining systems require metal or other poor insulator materials that come in contact with the inner and outer walls. The prior art also fails to provide for a seam fused or welded to eliminate crevices for bacteria or fungal growth. Moreover, conventional systems and methods do not use polymeric sheet stock for the exterior walls of the panel. Furthermore, conventional systems and methods do not use filament or cable for connecting panels.

### BRIEF SUMMARY OF EMBODIMENTS OF THE INVENTION

Embodiments of the present invention provide a building system/method and materials for enclosures that are better insulated, more dent resistant, easier and less expensive to construct. Additionally, such systems have no gaskets or open crevices between panels to create a health risk, eliminate expensive connectors and frames, and are lighter, stronger, and allow for colorizing without the risk of the color scratching or flaking off.

One particular embodiment provides a method for constructing food storage structures such as walk-in refrigerators, computer server cabinets, animal housing, and other temperature-controlled enclosures.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a cutaway, top view of a re-skinning embodiment for existing walk-in refrigerators;

FIG. 2 is a perspective view of the re-skinning embodiment of FIG. 1 for existing walk-in refrigerators;

FIG. 3 is a cutaway top view of an embodiment of the corner and two connecting straight structurally insulated panels, and means of connecting using a butt joint;

FIG. 4 is a perspective view of the embodiment of FIG. 3 of the corner and two connecting straight structurally insulated panels, and means of connecting using a butt joint;

FIG. 5 is a cutaway top view of an embodiment of the corner and two connecting straight structurally insulated panels, and means of connecting using a lap joint with interior conduit passage of a cable means for holding panels together;

FIG. 6 is a perspective view of the embodiment of FIG. 5 of the corner and two connecting straight structurally insulated panels, and means of connecting using a lap joint with interior conduit passage of a cable means for holding panels together

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward enclosed, temperature-controlled structures and methods for construction.

In one embodiment, the sheet metal skin in the current manufacture and assembly process is replaced by a polymer exterior. The polymer exterior may comprise a polycarbonate or similar polymer material that is impact resistant in a wide range of temperatures and is a better insulator than metals. Other embodiments for the exterior include, but are not limited to: fiberglass, plastic sheets, fabric, Mylar, urethane coatings, paint, and metal. The edges of each polymer are bent, as is the current sheet metal, to form a lip around the exterior of the panel frame. The panels are joined using a conventional cam and receiver configuration. The connected lips of each joined panel can be sealed with a conventional gasket technique, or can be fused together using plastic welding or glue. The resulting v-shaped crevice is then filled with a smooth, food-grade caulking or elastomeric glue. The glues are of sufficient viscosity to be applied vertically without sagging or dripping.

In another embodiment, structurally insulated panels are constructed using polymer sheets and expandable rigid foam, without the use of a built-in, reusable frame. This is accomplished by using a temporary, reusable frame to contain the expanding foam until cured. The frame is configured to create flat foam edges on some sides and extending polymer sheet stock on the connecting sides, forming a modified tongue and groove connection means. One embodiment includes lateral tubes to accept a braided cable of other high tensile strength filament to “string” the panels together. The filament then is tightened and secured to tie the panels together.

To run the connecting filament around corners, a rigid 90-degree tube is fixed to two face plates, one on each edge of the 90-degree corner. The lateral tubes for each connected panel are aligned, as is the edge connected to each corner unit. This corner design converts the force into compression of the panel joints and limits the pressure on the corner unit.

According to a further embodiment, a foam layer is utilized as a retrofit on existing structures. In this embodiment, a surface sheet is applied to the exterior surface. The interior surface of the foam sheet is attached to the wall of the existing structure The means for attachment means may include, but is not limited to: glue, physical means (e.g., rivets, screws, nails, etc.), and press-tit means. Similar to previous embodiments, the exterior surface may comprise fiberglass, plastic sheets, fabric, Mylar, urethane coatings, paint, and/or metal. The seams may comprise butt joints, lap joints, gaskets, fused seams, etc.

In some embodiments, the connecting edges of two panels may utilize a lap joint to join the exterior polymer sheets. In particular, the sheet stock on the male panel edge is creased slightly inward to create an indentation along the length of the edge. The female edge of the second panel has an extension of the sheet stock beyond the end of the foam interior. The resulting lap joint is fused on the interior and exterior faces by welding or use of an adhesive such as glue. The foam edges are simultaneously glued in a butt joint to yield a sealed, crevice-free connection.

In further embodiments, the system comprises a folded and complete structure with stringers joining inner and outer walls, wherein the system is adapted to be flipped open and filled with foam onsite. Such an embodiment may be preferred for mobile operations, providing a seamless and fast construction.

Additional embodiments may include a floor pan constructed of polymeric sheet stock to allow for leak free cleaning. The sides may be folded up and joined with welding or glues. In some such embodiments, the entire floor pan may be thermally formed to shape a shallow pool.

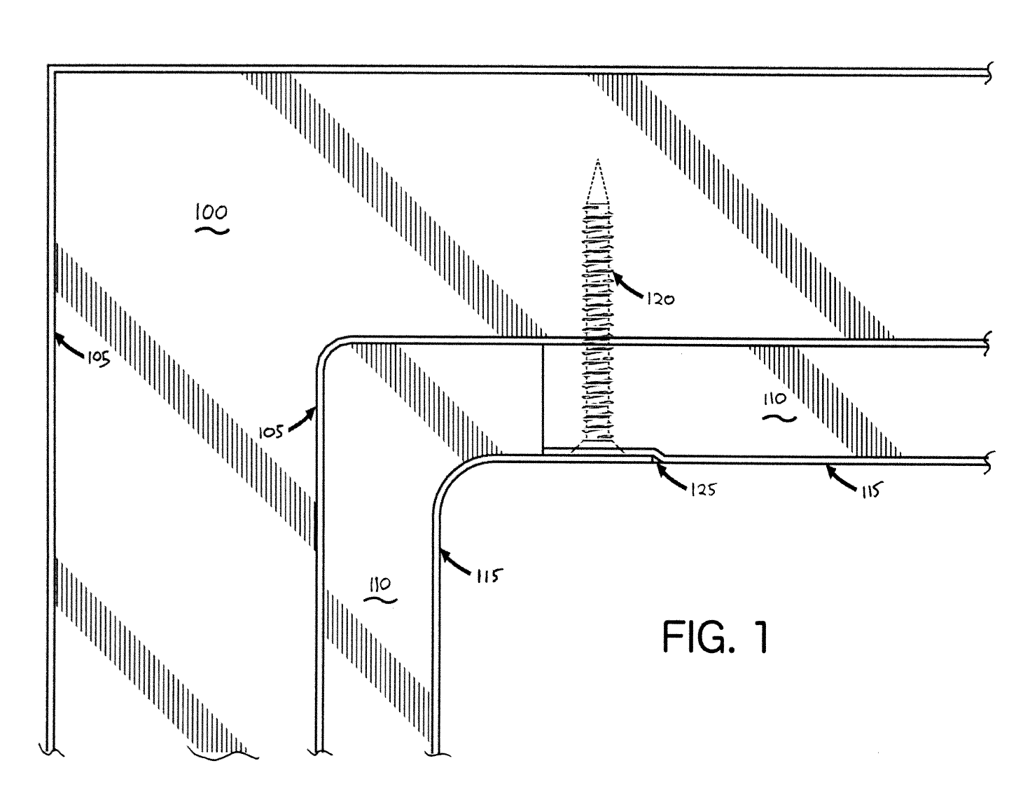

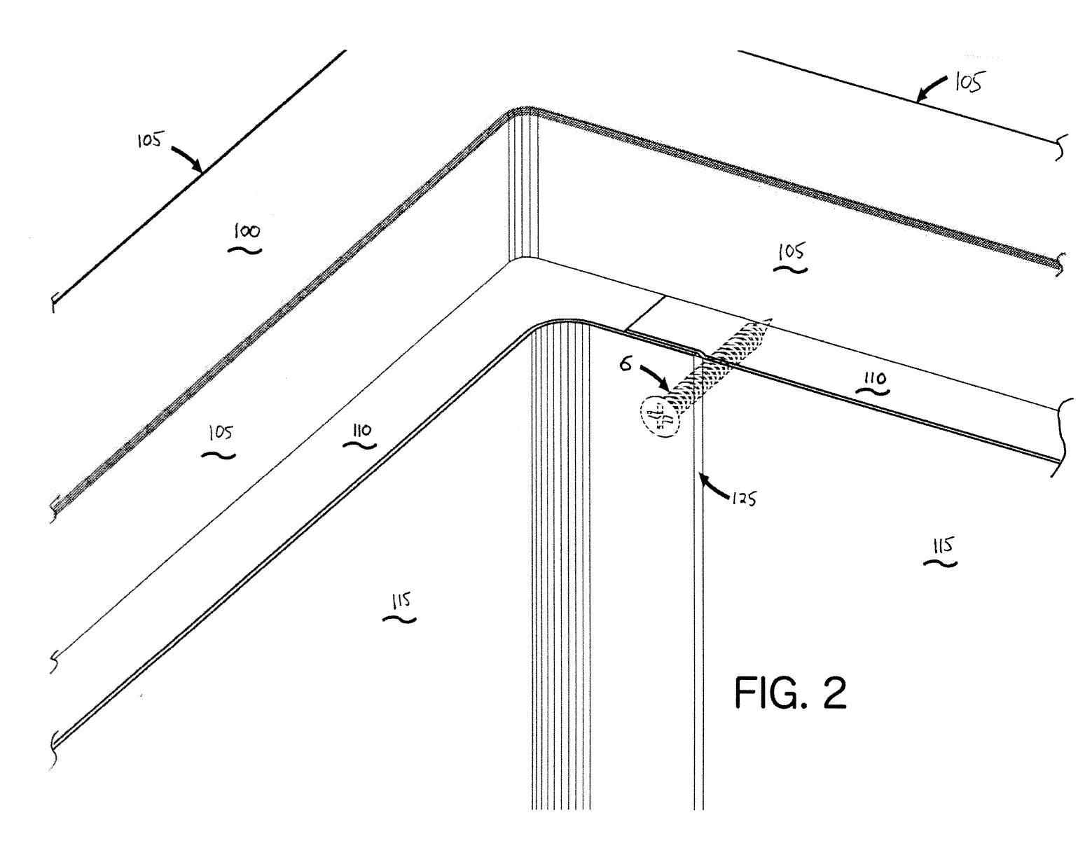

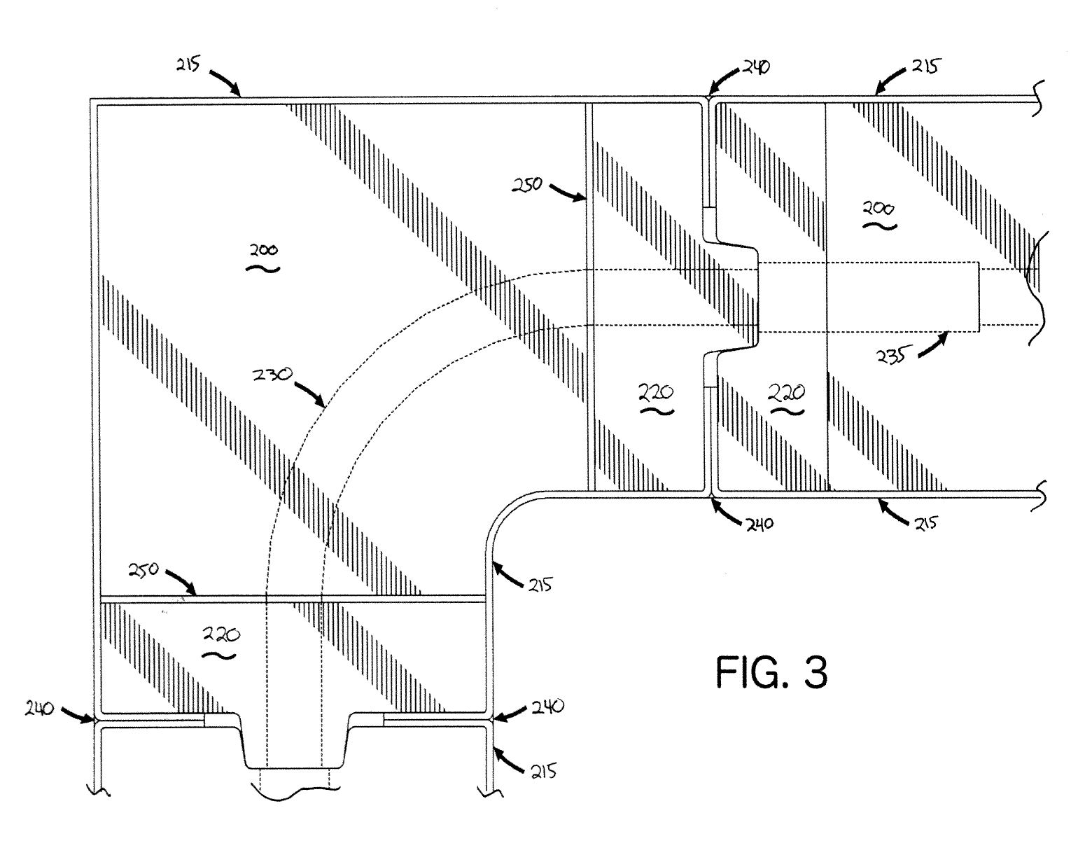

FIGS. 1 and 2 illustrate a cutaway top-down view and a perspective view, respectively, of a system/method and materials for adding an additional insulated layer on the surface of an existing structurally insulated panel 100 and its surface 105. In this embodiment, an old, inefficient, unattractive, or otherwise dysfunctional insulated panel 100 is reconditioned by attaching a new rigid foam panel 110 and surface sheet stock 115. Attachment means can include, but is not limited to physical anchors 120, and/or adhesive means at the juncture of the old surface 105 and the new foam 110. New structural panel 110, 115 is fabricated in a press of containment form as is typical for the construction of structurally insulated panels. In this case, the foam 110 bonds to the sheet stock 115 by chemical adhesion during the curing of the foam. Alternatively, the sheet stock 115 may be attached using adhesion means such as glue, adhesives, welding, adhesive tapes, or contact adhesive. In some embodiments, the sheets may be colorized, e.g., using traditional pigments. Additionally, the surface of a clear polymer sheet may be painted to yield a scratch resistant, rich, and lacquered appearance.

With further reference to FIGS. 1 and 2, connecting the sheet stock 115 can be accomplished by a plurality of joints such as lap joint 125, in which the receiving sheet stock 115 is bent inward to accept the smooth overlap of the sheet stock 115 of the connecting panel, thereby forming an even and smooth exterior surface. The lap joint 125 can be fused using numerous methods and or means including, but not limited to: heat welding, hot melt glues, solvent glues, adhesives, pressure sensitive adhesives, pressure sensitive two-sided tapes, solvent bonding, physical means such as rivets or screws, caulking, and sealants. In some implementations, the adhesion means can be tinted to a similar color as sheet stock 115 to yield a visually smooth transition. The inside corners and floor connections may have a curve with the inside radius at or above ¼″ to comply with National Sanitation Foundation standards for food service establishments. In further embodiments, a floor tub can be thermally-formed to wrap from the floor up the side walls to form a water-proof pan.

The surface of sheet stock 115 is designed to be sufficiently smooth to allow for easy wiping and cleaning. Sheet stock 115 and rigid foam 110 may also have a coating of, or be infused with, anti-microbial, anti-fungal, anti-mildew, or other germ killing agents (collectively, “anti-microbial agents”) to reduce the risk of germ growth. These anti-microbial agents can be applied topically to the outside of the sheet stock 115 forming a coating. In other embodiments, the anti-microbial agents are applied topically to the outside of the sheet stock 115 such that the agents soak into the sheet stock 115. According to further embodiments, the anti-microbial agents are formulated into the sheet stock 115 during extrusion and/or the agents are mixed into the foam 110.

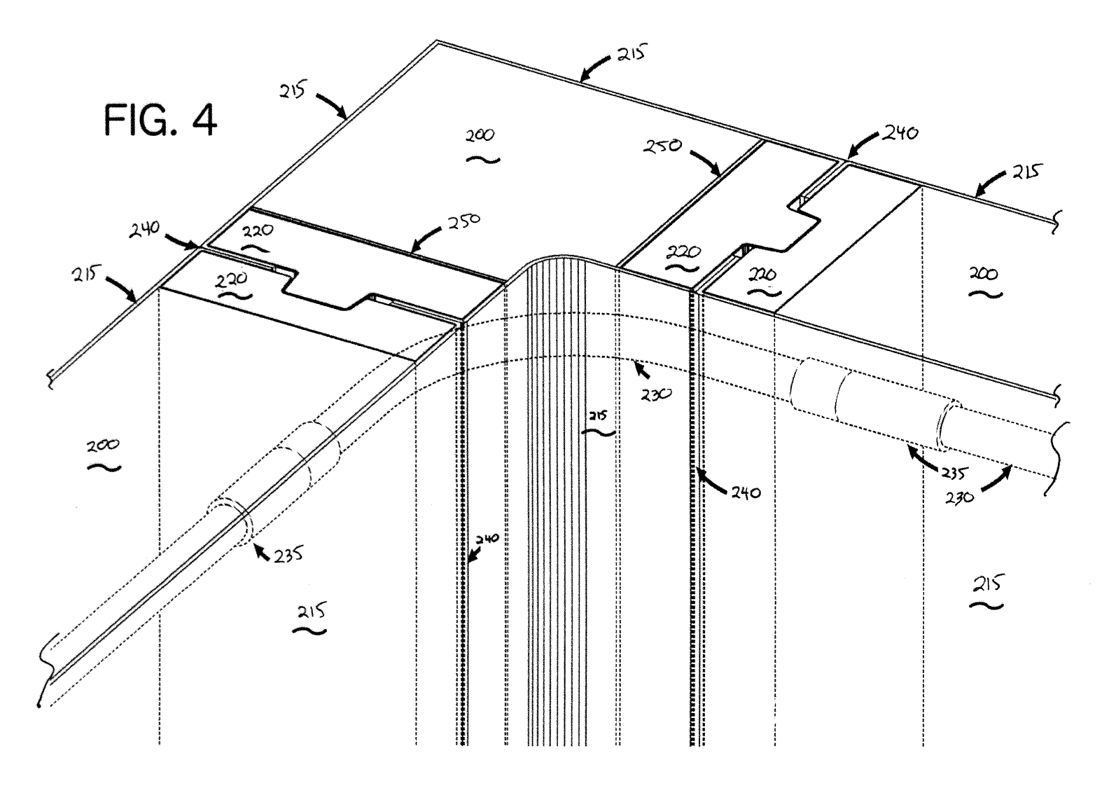

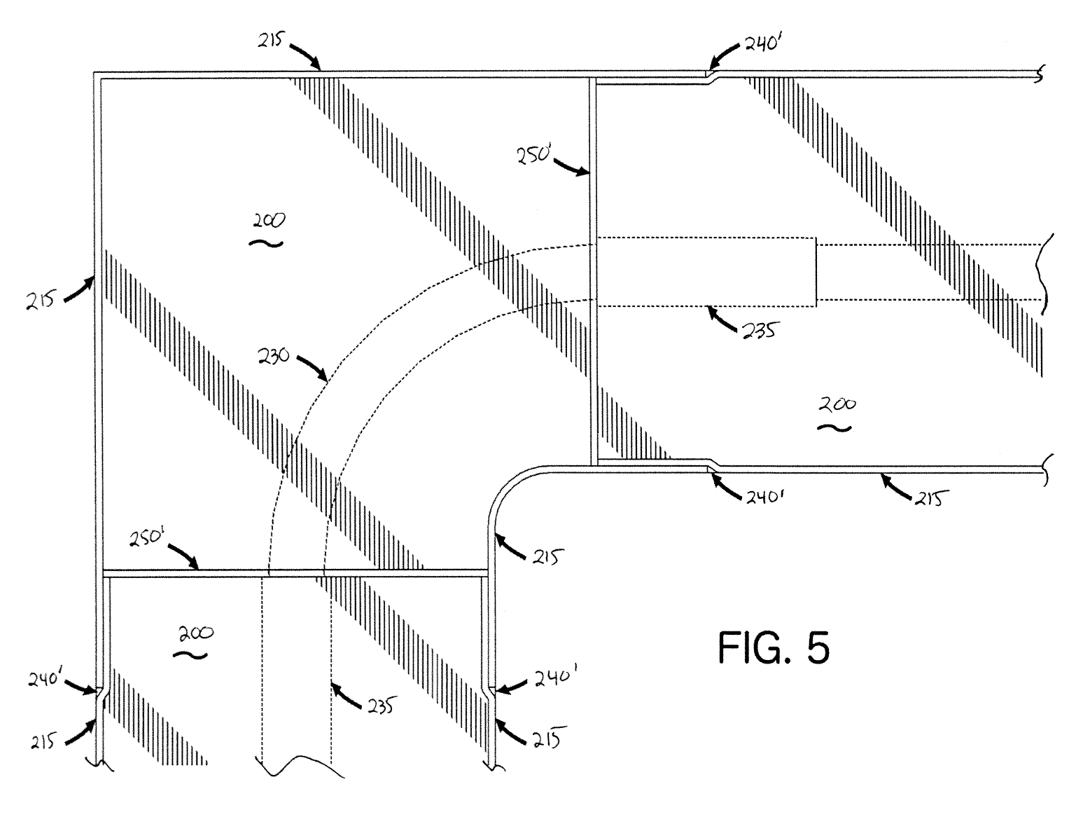

FIGS. 3 and 4 illustrate a cutaway top down view and a perspective view, respectively, of a structurally insulated panel and connection means. In particular, rigid insulating foam panels 200 are covered by a pair of resin-based sheet stock 215 such as plastic, fiberglass, or other polymeric material. The sheet stock 215 may be creased so as to bend around a structural rail 220.

As depicted, mating rails 220 may incorporate a tongue and groove configuration, and may be attached together using an adhesive such as glue. The panel system incorporates a lateral conduit 230 through foam panels 200 and rails 220 such that a cable may be threaded through the conduit 230, and then tightened to provide structural rigidity. At the mating edges of two panels 200, a sleeve 235 is provided with an inside diameter exceeding the outside diameter of the conduit 230 to align and connect the conduit 230. This results in a smooth inside surface to facilitate insertion of the cable and to help align the panels. A butt joint 240 between adjacent rails 220 may be sealed by use of a gasket that acts as a weather strip. In some embodiments, the butt joint 240 may be fused utilizing plastic welding or any one of a plurality of fusing agents such as solvent glue or epoxy. Element 250 represents a connection point between a foam panel 200 and a structural rail 220, for example using an adhesive such as glue.

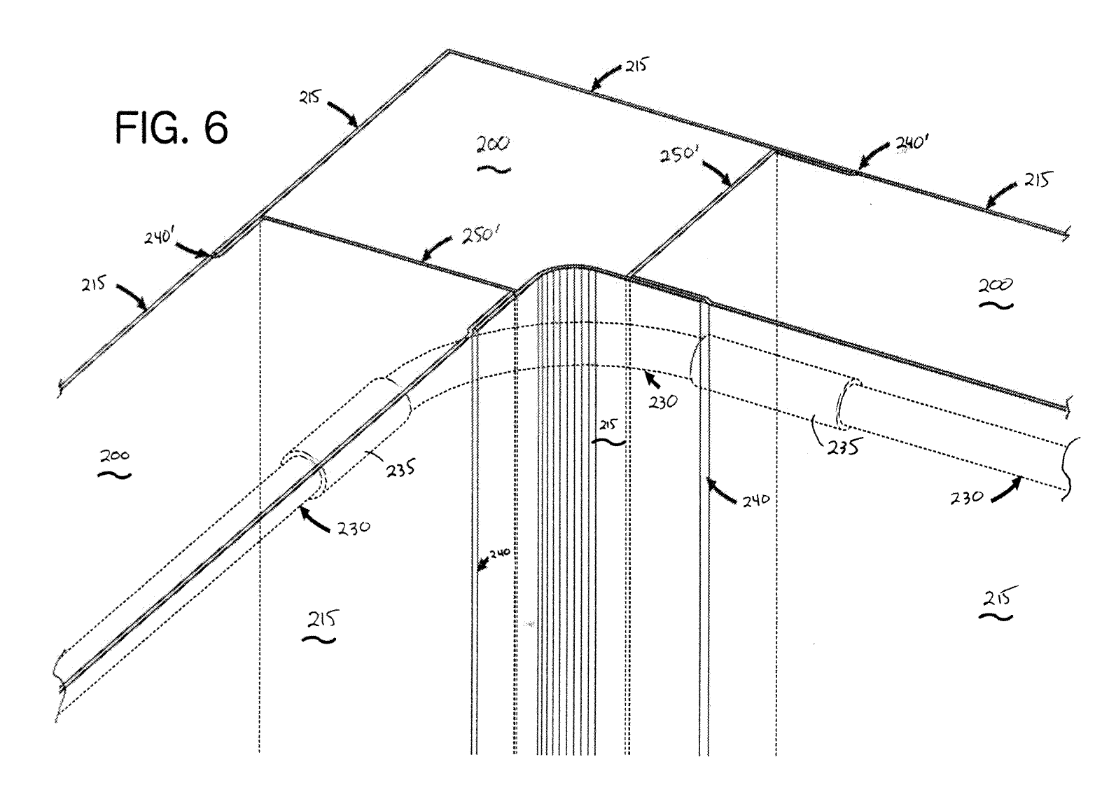

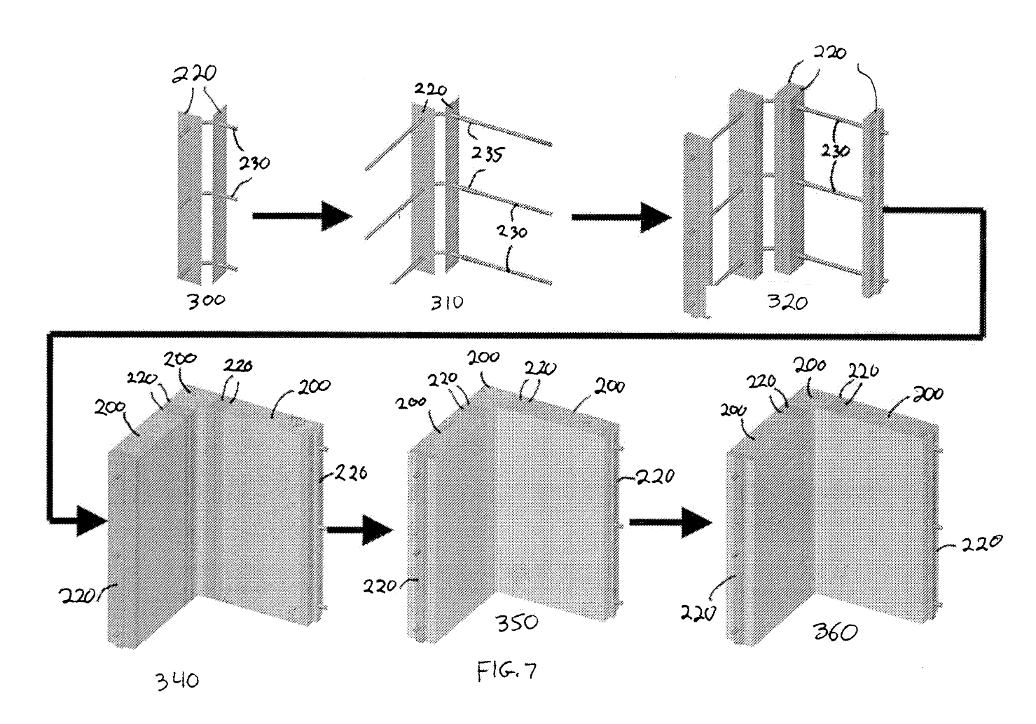

FIGS. 5 and 6 illustrate a cutaway top down view and a perspective view, respectively, of a structurally insulated panel. This embodiment is similar to that of FIGS. 3 and 4 (except that no rails are employed), and like elements have been numbered accordingly. The structurally insulated foam panels 200 are assembled using a reusable frame 215 whose purpose is to contain the foam 200 as it rises. The female edge of joining panels embodies an extension of the sheet stock 215 some distance beyond the edge of the foam 200. The male edge of the joining panels embodies a inward jog in the sheet stock 215 of approximate depth as the thickness of the sheet stock 215 resulting in a lap joint 240′. The sheet stock 215 can be fused at the lap joint 240′ utilizing one of a plurality of methods and/or means including, but not limited to: welding, solvent glues, solvent welding, and epoxies. Panels 200 may be connected by a lateral conduit 230 that houses a cable that can be tightened to affect a binding of the panels 200 to each other, thereby providing increase structural rigidity. At the mating edges of two panels 200, a sleeve 235 is provided having an inside diameter exceeding the outside diameter of the conduit 230. The sleeve 235 helps align and connect the conduit 230, thus yielding a smooth inside surface to facilitate insertion of the cable and align the panels 200. Element 250′ represents a connection point between foam panels 200, for example using an adhesive such as glue.

FIG. 7 illustrates a method for manufacturing a structurally insulated panel and connection means. In step 300, a corner unit is formed by threading a cable through the conduit 230 passing through structural rails 220. Step 310 depicts the internal rigid conduit 230 including sleeves 235 to align and connect the conduit 230 and facilitate insertion of the cable. In step 320, the frame is completed by attaching an additional rail 230 to each existing rail 220 in the corner unit, as well as adding addition structural rails 220 at the distal ends of the conduit 230. The foam 200 is inserted into the frame in step 340. In some embodiments, the panel is retained in a large press, and liquid urethane foam is injected through a small opening such that the foam then expands to fill the void. Once the foam cures, the finished panel is removed from the press. In step 350, the sheet stock 215 is attached to the foam panel 200, e.g., using glue, adhesives, welding, adhesive tapes, or contact adhesive. In step 360, the seams are fused. The seams may comprise butt joints, lap joints, gaskets, fused seams, etc. The sheet stock may comprise polymer sheets comprising plastic or polycarbonate

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. These illustrations and their accompanying description should not be construed as mandating a particular architecture or configuration.

1. An insulated panel system for enhanced insulation of an existing structure, the system comprising:
an additional insulated layer provided on the surface of existing structurally insulated panel;
attachment means for attaching the additional insulated layer to the existing structurally insulated panel;
wherein the additional insulated layer comprises a rigid foam panel and surface sheet stock sandwiching the foam panel.

2. The system of claim 1, wherein the foam bonds to the sheet stock by chemical adhesion during the curing of the foam.

3. The system of claim 1, wherein the sheet stock is attached to the foam panel using glue, adhesives, welding, adhesive tapes, or contact adhesive.

4. The system of claim 1, wherein the sheet stock comprises polymer sheets comprising plastic or polycarbonate, and wherein the sheet stock is coated with a nano glass coating to improve scratch resistance and reduce the transfer of organic or inorganic molecules.

5. The system of claim 1, wherein an inner surface of the sheet stock is non-planar in order to increase a physical bond with the foam.

6. The system of claim 1, wherein the sheet stock comprises twin wall polymers with a perforated inner wall.

7. The system of claim 1, wherein the sheet stock comprises ridges with broad tops to trap foam inside.

8. The system of claim 1, wherein the sheet stock comprises irregular shaped protrusions that allow the foam to conform, thereby converting tensile adhesion with shear force adhesion.

9. The system of claim 1, wherein the additional insulating layer provides improved temperature control for walk-in refrigeration, computer cabinets, animal shelters, or other temperature controlled enclosures.

10. The system of claim 1, wherein adjacent panels are joined by way of a butt joint, a lap joint, tongue and groove with a lap joint, butting and gluing the foam, cabling, welding, or glue.

11. The system of claim 1, further comprising a corner connector having an inside radius of at least ¼″.

12. The system of claim 1, further comprising a conduit system for cabling.

13. The system of claim 1, wherein the sheet stock and rigid foam have a coating of, or are infused with, anti-microbial agents to reduce the risk of germ growth.

14. The system of claim 3, wherein the anti-microbial agents are either applied topically to the outside of the sheet stock forming a coating, or are applied topically to the outside of the sheet stock such that the agents soak into the sheet stock, or are formulated into the sheet stock during extrusion or the anti-microbial agents are mixed into the foam.

15. A system, comprising:
a structurally insulated panel and connection means, comprising:
a plurality of rigid insulating foam panels;
a plurality of mating rails to provide structural support; and
resin-based sheet stock sandwiching the foam panels and mating rails.

16. The system of claim 15, wherein the mating rails incorporate a tongue and groove configuration to facilitate attachment to one another.

17. The system of claim 15, further comprising a lateral conduit disposed through the foam panels and the mating rails, and a cable threaded through the conduit and tightened to provide structural rigidity.

18. The system of claim 17, further comprising a sleeve disposed around the conduit at mating edges of two panels, the sleeve having an inside diameter exceeding an outside diameter of the conduit.

20. The system of claim 15, wherein the foam bonds to the sheet stock by chemical adhesion during the curing of the foam.

21. The system of claim 15, wherein the sheet stock is attached to the foam panel using glue, adhesives, welding, adhesive tapes, or contact adhesive.

22. The system of claim 15, wherein the sheet stock comprises polymer sheets comprising plastic or polycarbonate, and wherein the sheet stock is coated with a nano glass coating to improve scratch resistance and reduce the transfer of organic or inorganic molecules.

23. The system of claim 15, wherein an inner surface of the sheet stock is non-planar in order to increase a physical bond with the foam.

24. The system of claim 15, wherein the sheet stock comprises twin wall polymers with a perforated inner wall.

25. The system of claim 15, wherein the sheet stock comprises ridges with broad tops to trap foam inside.

26. The system of claim 15, wherein the sheet stock comprises irregular shaped protrusions that allow the foam to conform, thereby converting tensile adhesion with shear force adhesion.

27. The system of claim 15, wherein adjacent panels are joined by way of a butt joint, a lap joint, tongue and groove with a lap joint, butting and gluing the foam, cabling, welding, or glue.

28. The system of claim 15, further comprising a corner connector having an inside radius of at least ¼″.

29. The system of claim 15, wherein the sheet stock and rigid foam have a coating of, or are infused with, anti-microbial agents to reduce the risk of germ growth.

30. The system of claim 31, wherein the anti-microbial agents are either applied topically to the outside of the sheet stock forming a coating, or are applied topically to the outside of the sheet stock such that the agents soak into the sheet stock, or are formulated into the sheet stock during extrusion or the anti-microbial agents are mixed into the foam.
